(19) United States
(12) Patent Application Publication
(10) Pub. No.: US 2013/0152074 A1
(43) Pub. Date: Jun. 13, 2013

(54) METHOD FOR AUTOMATIC CONSECUTIVE INSTALLING OPERATING SYSTEMS

(71) Applicant: Chia-Wei Yeh, New Taipei City (TW)

(72) Inventor: Chia-Wei Yeh, New Taipei City (TW)

(21) Appl. No.: 13/368,307

(22) Filed: Feb. 7, 2012

(30) Foreign Application Priority Data
Dec. 12, 2011 (TW) 100145851

(51) Int. Cl. G06F 9/445; G06F 15/16

(52) U.S. Cl. 717/178

(57) ABSTRACT

A method for automatic consecutive installing operating systems is disclosed. The method includes establishing a transmission link between a server device and a device under test (DUT), downloading a preinstallation environment module from the server device via the transmission link, utilizing the preinstallation environment module to perform a boot process, obtaining an installation file from the server device and installing a first operating system on the DUT according to the installation file, modifying the installation file to indicate that a second operating system is a next installation operating system, and utilizing the preinstallation environment module to perform a boot process again and installing the second operating system on the DUT according to the modified installation file.

### BACKGROUND OF THE INVENTION

1. Field of the Invention

The invention relates to a method of installing operating systems, and more particularly, to a method capable of automatic consecutive installing Microsoft operating system.

2. Description of the Prior Art

Hardware and software of computer products have to be tested before the computer products are brought to the market for product quality ensuring. For commercial mode of mass production, when manufacturers produce huge numbers of the computer products with different features, manufacturers have to rely on a testing system with high efficiency to test the computer products before shipping the computer products, so as to test and verify whether the functions of the computer products operate well and fit requirements of quality control. After testing and verifying the functions of the computer products, the computer products may be allowed to offer to the consumers. In the existing testing systems, a network testing system is most suitable for high efficiency application. The current most commonly used network testing system mainly utilized Preboot Execution Environment (PXE) of remote installation technology for executing testing processes. The operators can set up testing files and testing environment files on a server in advance according to the computer products, so as to allow devices under test (DUTs) to download testing files and testing environment files and to execute the testing processes. Then, the operators can utilize a testing database for providing related testing parameters and collecting testing results of DUTs.

As to the DUTs of computer products, the DUTs of computer products generally need to be tested under different operating system environments, to ensure the DUTs of computer products work normally under each operating system consumer may install. In other words, different operating systems are installed on the DUTs for executing the related testing processes. However, in the conventional network testing system, operators have to manually install next operating system under test after finishing each operating system. As a result, huge human resource cost would be wasted.

In order to decrease the human resource cost, the prior art provides a method of automatic consecutive installing operating systems for installing different operating systems under test on the DUTs. The method mainly utilizes the Preboot Execution Environment for executing network boot, and then installing the operating system under test on the DUTs. After installing the operating system under test, the method clears boot data stored in a boot record of a hard disk, so as to skip hard disk boot process and to execute network boot in following boot process. Then, the method utilizes network for automatic installing the next operating system under test on the DUTs. However, the Preboot Execution Environment generally has a boot file of one Microsoft Windows operating system for executing network boot. In such a situation, although the DUTs can achieve boot process, each version of Microsoft Windows operating systems needs a corresponded boot file to execute installing process, so the above mentioned method of automatically consecutive installing is limited to automatically consecutive install the Linux operating systems and install one Microsoft Windows operating system. In brief, the above mentioned method of automatic consecutive installing operating systems cannot apply in installing multiple Microsoft Windows operating systems.

Therefore, how to achieve automatically consecutive installing multiple Microsoft Windows operating systems for improving efficiency of testing computer products, has been a major focus of the industry

### SUMMARY OF THE INVENTION

Therefore, the invention mainly provides a method for automatically consecutive installing operating systems.

An embodiment of the invention discloses a method for automatic consecutive installing operating systems, comprising: establishing a transmission link between a server device and a device under test (DUT); downloading a preinstallation environment module from the server device via the transmission link; utilizing the preinstallation environment module to perform a boot process; obtaining an installation file from the server device and installing a first operating system on the DUT according to the installation file; modifying the installation file to indicate that a second operating system is a next installation operating system; and utilizing the preinstallation environment module to perform a boot process again and installing the second operating system on the DUT according to the modified installation file.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a testing system of an automatic consecutive installing system according to an embodiment of the invention.

FIG. 2 is a schematic diagram of a process according to an embodiment of the invention.

FIG. 3 is a first operating schematic diagram of a testing system according to an embodiment of the invention.

FIG. 4 is a second operating schematic diagram of a testing system according to an embodiment of the invention.

### DETAILED DESCRIPTION

Each version of Microsoft Windows operating systems has corresponded boot file and all versions of the boot file can be used to execute boot process, but each version of Microsoft Windows operating system has to use the corresponded boot file to execute boot process when installing each version of Microsoft Windows operating systems. Therefore, in order to improve disadvantages mentioned above, the invention discloses the method of automatically consecutive installing different Microsoft Windows operating systems, for applying in the testing systems of the industry and allowing computer device under test to automatically consecutive execute testing processes of different Microsoft Windows operating systems.

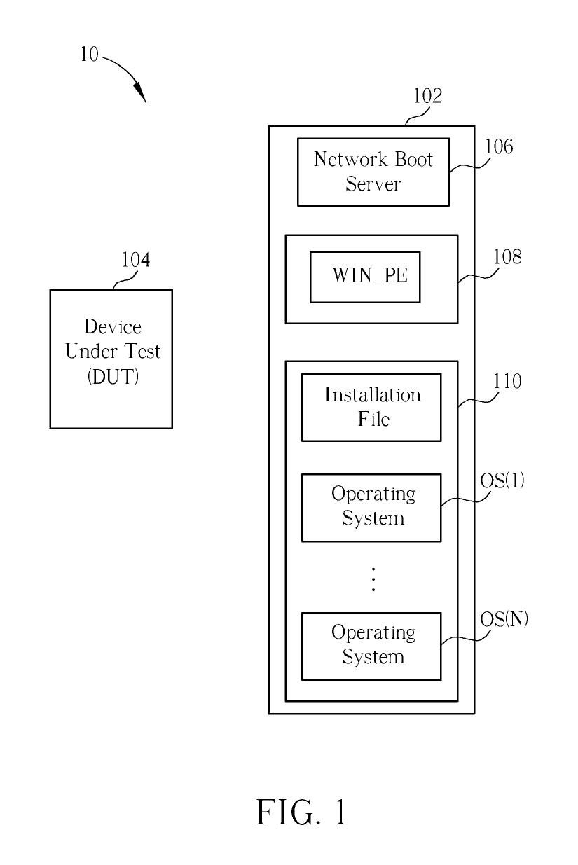

Please refer to FIG. 1, where FIG. 1 is a schematic diagram of a testing system 10 capable of automatically consecutive installing operating systems according to an embodiment of the invention. The testing system 10 comprises a sever device 102 and a device under test (DUT) 104. The testing system 10 is utilized for sequentially installing each of the operating system under test (i.e. installation files of operating systems OS(1)˜OS(n)) on the DUT 104, so as to allow DUT 104 to operate in the installed operating system and accordingly execute each testing process. The sever device 102 comprises a network boot server 106, a data server 108 and a remote storage server 110. The data server 108 stores a Preinstallation Environment (PE) module WIN_PE. The remote storage server 110 stores an installation file and installation files of operating system OS(1)˜OS(n). Preferably, the server device 102 is a server device with a function of Preboot Execution Environment (PXE), and the DUT 104 is an electronic device with computer systems and can operate in the installed operating system. The operating system OS(1)˜OS(n) can be stored in the remote storage server 110 in a format of image file, and each operating system can be a Microsoft Windows operating system. The Preboot Environment module WIN_PE can be a Windows Preinstallation Environment (Windows PE). In other words, in the testing system 10, each of the Microsoft operating system stored in the remote storage server 110 can be automatically installed on the DUT 104, so as to allow the DUT 104 to operate in the installed Microsoft Windows operating system for performing all kinds of hardware and software testing.

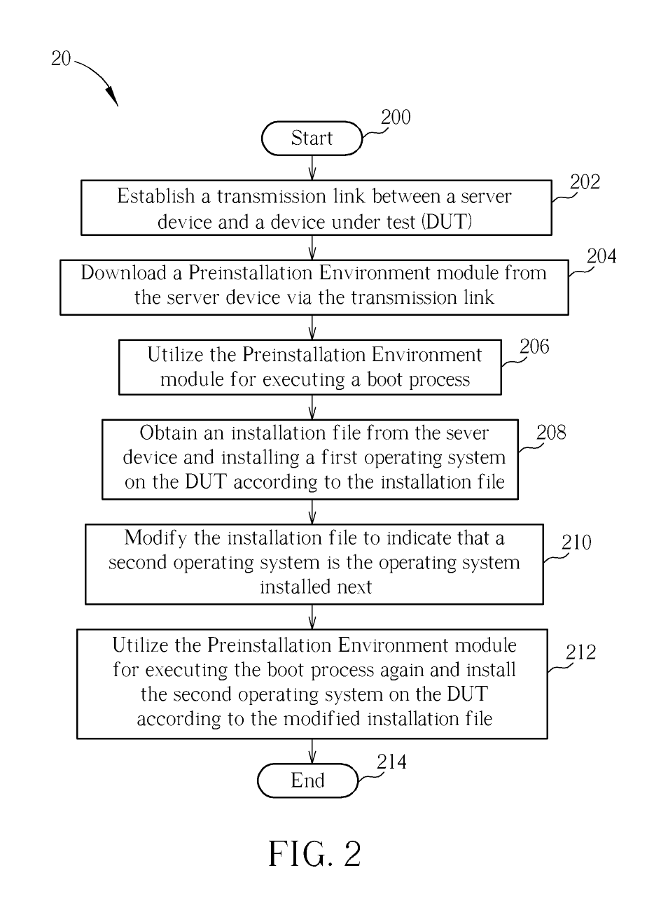

The method of automatically and consecutively installing the operating systems under test stored in the server device 102 on the DUT 104 can be summarized into a process 20. Please refer to FIG. 2, the process 20 includes:

Step 200: Start.

Step 202: Establish a transmission link between a server device and a device under test (DUT).

Step 204: Download a Preinstallation Environment module from the server device via the transmission link.

Step 206: Utilize the Preinstallation Environment module for executing a boot process.

Step 208: Obtain an installation file from the sever device and installing a first operating system on the DUT according to the installation file.

Step 210: Modify the installation file to indicate that a second operating system is the operating system installed next.

Step 212: Utilize the Preinstallation Environment module for executing the boot process again and install the second operating system on the DUT according to the modified installation file.

Step 214: End.

Briefly speaking, according to the process 20, after establishing the transmission link between the sever device 102 and DUT 104, the Preinstallation Environment module WIN_PE is downloaded to the DUT 104. Then, the DUT 104 utilizes the Preinstallation Environment module WIN_PE for performing the boot process and for obtaining an installation file from the sever device 102. Furthermore, the operating system OS(1) is installed on the DUT 104. As a result, the DUT 104 can operates in the operating system OS(1) and perform the related hardware/software testing processes. In the meantime, the boot record of DUT 104 is cleared and the installation file in the server device 102 is modified to indicate that the operating system OS(2) is the operating system installed next. Finally, the DUT 104 utilizes the Preinstallation Environment module WIN_PE for performing the boot process again and the operating system OS(2) is installed on the DUT 104 according to the modified installation file. Similarly, the DUT 104 can operates in the operating system OS(2) and performs related hardware/software testing processes. By the same token, the operating systems OS(1)˜OS(n) can be automatically and consecutively installed on the DUT 104 to perform all kinds of testing processes.

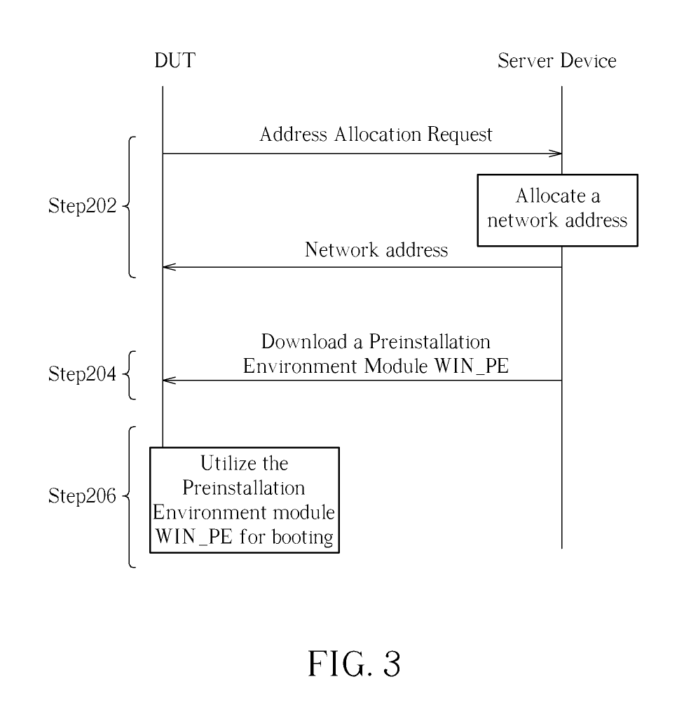

In detail, when the testing system 10 wants to consecutively install multiple Microsoft Windows operating systems on the DUT 104, a transmission link between the server device 102 and the DUT 104 can be established via Step 202. For example, please refer to FIG. 3, where FIG. 3 is a first operating schematic diagram of the testing system 10 according to an embodiment of the invention. Operational concepts of Steps 202 to 208 of process 20 are explained through FIG. 3. Assuming the network boot server 106 is a Dynamic Host Configuration Protocol Server (DHCP Server), the data server 108 is a Trivial File Transfer Protocol Sever (TFTP Server) and the remote storage server 110 is a SAMBA server using a Server Message Block (SMB) communication protocol. First, the DUT 104 transmits an address allocation request to the server device 102. Then, the network boot server 106 of the server device 102 allocates a network address to the DUT 104 according to the address allocation request. In such a situation, the DUT 104 becomes one of network nodes of the testing system 10. In the meantime, the server device 102 also provides related information of the data server 108 (ex. the IP address, stored information of data server 108) to the DUT 104.

In Step 204, through the established transmission link, the Preinstallation Environment module WIN_PE stored in the server device 102 is downloaded to the DUT 104. Then in Step 206, the DUT 104 utilizes the Preinstallation Environment module WIN_PE for executing the boot process. For example, please continuously refer to FIG. 3, the DUT 104 transmits a downloading request to the data server 108 according to the related information of the data server 108, and downloads the Preinstallation Environment module WIN_PE from the data server 108. After the Preinstallation Environment module WIN_PE is downloaded to the DUT 104, the DUT 104 utilizes the Preinstallation Environment module WIN_PE for executing the remote boot process.

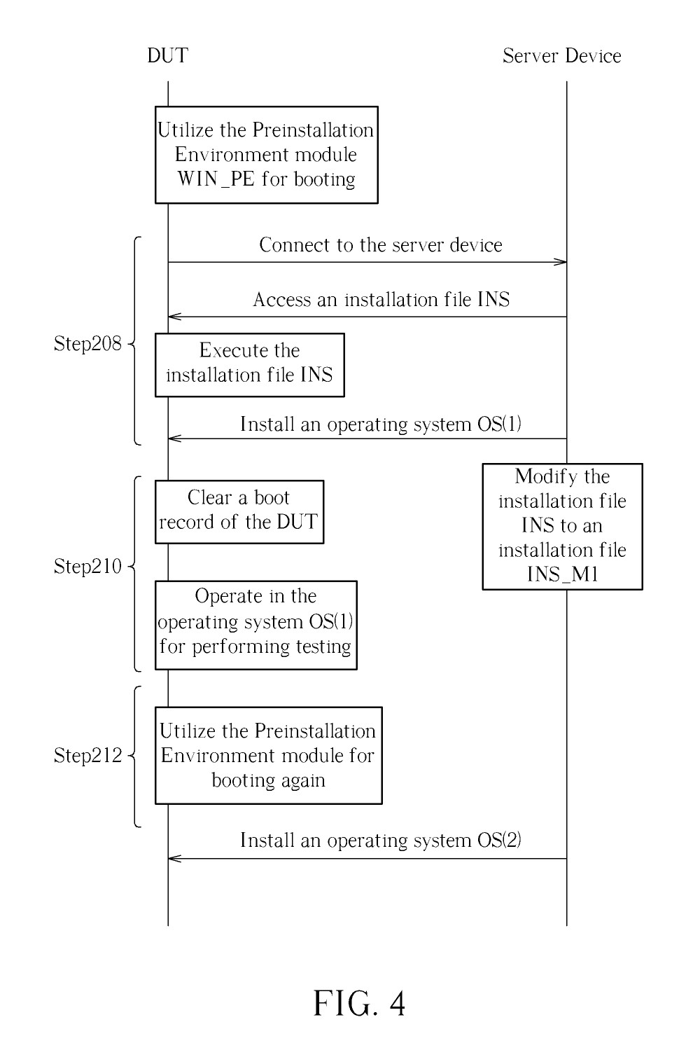

Furthermore, in Step 208, the DUT 104 obtains and executes the installation file from the remote storage server 110 of the server device 102, so as to install the operating system OS(1) on the DUT 104. For example, please refer to FIG. 4, where FIG. 4 is a second operation schematic diagram of the testing system 10 according to an embodiment of the invention. The operational concepts of Steps 208 to 210 can be explained via FIG. 4. As mentioned above, in Step 206, the DUT 104 utilizes the Preinstallation Environment module WIN_PE for executing the remote boot process. In the process of boot initiation, an initiation file, such as a Start.cmd file, of the Preinstallation Environment module WIN_PE is executed. Therefore, the initiation file is set in advance to indicate that the DUT 104 is able to connect to the server device 102 and load an installation file INS stored in the sever device 102 after finishing the boot process. Then, the DUT 104 executes the loaded installation file INS. For example, when the remote storage server 110 is the SAMBA server using the SMB communication protocol, the initiation file can be set to indicate that the DUT 104 would connect to a SAMBA remote folder of the remote storage sever 110 and load the installation file INS stored in the SAMBA remote folder after finishing the boot process. Besides, the installation files INS is utilized for indicating the DUT 104 to install the operating system OS(1). In other words, after executing the installation file INS, the operating system OS(1) stored in the remote storage server 1110 is downloaded and installed on the DUT 104. Therefore, once the initiation file of the Preinstallation Environment module WIN_PE is set properly and the initiation file is executed in the process of the boot initiation, the DUT 104 connects to the SAMBA remote folder of the remote storage server 110 for obtaining the installation file INS after finishing the boot process. Then, after executing the installation file INS, the operating system OS(1) stored in the remote storage server 110 is remotely installed on the DUT 104 via network.

After the operating system OS(1) is installed on the DUT 104, the DUT 104 can operate in the operating system OS(1) for performing the related testing processes and accordingly generating a test result. For example, the related testing processes comprises rebooting, pressure test, basic input/output system, hardware driver, network card driver, power, baseboard management controller (BMC), temperature measuring, wake on LAN (WOL), etc.

Furthermore, since the operating system OS(1) has installed on the DUT 104, the installation file INS stored in the SAMBA remote folder of the remote storage server 110 is modified to indicate the operating system installed next. For example, please continuously refer to FIG. 4, since the operating system OS(1) of the remote storage server 110 is remotely installed on the DUT 104 in Step 206, generally, an automatic deployment file, ex. an autounattend.xml file, is executed while installing the operating system. Therefore, the automatic deployment file can be set in advance to indicate the DUT 104 to modify the installation file INS stored in the SAMBA remote folder of the remote storage server 110 into an installation file INS_M1. Wherein, the modified installation file INS_M1 is used to indicate the operating system installed next, for example, the operating system OS(2). In other words, in Step 210, the installation file INS stored in the remote SAMBA folder of the remote storage server 110 is modified into the installation file INS_M1 through executing the automatic deployment file of the operating system. In such a situation, the next time the DUT 104 utilizes the Preinstallation Environment module WIN_PE for executing the boot process and connecting to the SAMBA remote folder of the remote storage server 110, the installation file obtained by the DUT 104 becomes the installation file INS_M1.

On the other hand, since the Preinstallation Environment module WIN_PE is virtually established in a memory and executes the boot process in the memory, the boot record in the memory has to be cleared in Step 210, so as to use the Preinstallation Environment module WIN_PE to perform the boot process. For example, the automatic deployment file can be set in advance to indicate that the boot record of the DUT 104 is cleared while executing the installation of the operating system. As a result, when the DUT 104 reboots, the DUT 104 will uses the Preinstallation Environment module WIN_PE to perform the boot process because the DUT 104 cannot find the hard disk. In addition, in Step 210, the above mentioned test result can be transmitted to the server device 102. For example, the automatic deployment file can be set in advance to indicate that the related test result is transmitted to the server device 102 for analyzing and evaluating after executing related testing processes.

In brief, once the automatic deployment file of each operating system is set properly in advance, each time the automatic deployment file is executed while installing the operating systems, the installation file stored in the SAMBA remote folder of the remote storage sever 110 is modified into the installation file for indicating the operating system installed next. Moreover, through clearing the boor record of the DUT 104, the DUT 104 can utilize the Preinstallation Environment module WIN_PE for executing the boot process while rebooting. Besides, through transmitting the test result to the server device 102, the analysis and the evaluation are generated more conveniently.

Furthermore, in Step 212, the DUT 104 utilizes the Preinstallation Environment module WIN_PE for executing the boot process again, thus, the DUT 104 executes the initiation file of the Preinstallation Environment module WIN_PE again and connects to the SAMBA remote folder of remote storage server 110 for loading the installation file INS_M1. After utilizing the Preinstallation Environment module WIN_PE for executing the boot process, various versions of Microsoft Windows operating systems can be installed, and the problem of the Microsoft Windows operating system required to be installed with the corresponded version of boot file does not occur. Therefore, after executing the installation file INS_Ml, the operating system OS(2) is installed on the DUT 104. Similarly, the DUT 104 also modifies the installation file INS_M1 stored in the SAMBA remote folder of the remote storage server 110 to indicate the operating system installed next. For example, the installation file INS_M1 is modified into an installation file INS_M2 to indicate that an operating system OS(3) is the operating system installed next.

In brief, after utilizing the Preinstallation Environment module WIN_PE for executing the boot process again, the DUT 104 performs Steps 206 to 210 to install the second operating system and to modify the installation file to indicate the operating system installed next. By the same token, all the Microsoft Windows operating systems are sequentially installed on the DUT 104 to perform the related testing processes.

In brief, according to process 20, the DUT 104 utilizes the Preinstallation Environment WIN_PE for executing the boot process and setting the automatic deployment file for modifying the installation file stored in the server device 102 to arrange the operating system installed next, so as to achieve the requirement of automatic consecutive installing Microsoft Windows operating systems.

Noticeably, the embodiments of process 20 are only applied for explaining the invention, and the invention is not limited thereto. Without violating the spirit of the invention, other middle steps can be add into the steps of process 20 shown in FIG. 2 or multiple steps of the process 20 can be combined into a step. Besides, the process 20 is not limited to be executed in the sequence shown in FIG. 2 if a substantial result can be obtained.

To sum up, the disadvantage of the method of automatic consecutive installing in the prior art is unable to consecutively install multiple Microsoft Windows operating systems, such that the method of automatic consecutive installing in the prior is not suitable for installing multiple Microsoft Windows operating systems. The invention utilizes the Preinstallation Environment module WIN_PE for executing the boot process and utilizes setting of the automatic deployment file for modifying the installation file stored in the server device to arrange the operating system installed next. As a result, the goal of automatic consecutively installing Microsoft Windows operating system is achieved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for automatic consecutive installing operating systems, comprising:
establishing a transmission link between a server device and a device under test (DUT);
downloading a preinstallation environment module from the server device via the transmission link;
utilizing the preinstallation environment module to perform a boot process;
obtaining an installation file from the server device and installing a first operating system on the DUT according to the installation file;
modifying the installation file to indicate that a second operating system is a next installation operating system; and
utilizing the preinstallation environment module to perform a boot process again and installing the second operating system on the DUT according to the modified installation file.

2. The method of claim 1, wherein the step of establishing the transmission link between the server device and the DUT comprising:
utilizing the DUT for transmitting an address allocation request to the server device; and
utilizing the server device for allocating a network address for the DUT according to the address allocation request to establish the transmission link.

3. The method of claim 1, wherein the step of downloading the preinstallation environment module via the transmission link comprising:
obtaining information related to a data server from the server device; and
connecting to the data server according to the obtained information related to the data server to download the preinstallation environment module.

4. The method of claim 1, wherein the step of obtaining an installation file from the server device and installing the first operating system on the DUT according to the installation file comprising:
obtaining the installation file from the server device; and
executing the installation file to install the first operating system, stored in a remote storage server of the server device, on the DUT.

5. The method of claim 1, wherein the step of utilizing the preinstallation environment module to perform the boot process again and installing the second operating system on the DUT according to the modified installation file comprising:
utilizing the preinstallation environment module for executing the boot process again;
obtaining the modified installation file from the server device, and installing the second operating system on the DUT according to the modified installation file;
modifying the installation file again to indicate the operating system installed next is a third operating system; and
utilizing the preinstallation environment module for executing the boot process again, and installing the third operating system on the DUT according to the modified installation file.

6. The method of claim 1, further comprising:
clearing a boot record of the DUT after installing the first operating system on the DUT.

7. The method of claim 1, further comprising:
operating in the first operating system and executing a testing process to generate a test result after installing the first operating system in the DUT; and
transmitting the test result to the server device.
